(19) United States
(12) Patent Application Publication
(10) Pub. No.: US 2004/0013805 A1
(43) Pub. Date: Jan. 22, 2004

(54) Processing method of creating rainbow color, method of manufacturing article which presents rainbow-colored reflective luster, and article which presents rainbow-coloured reflective luster

(76) Inventors: Itsuo Nagata, Osaka (JP); Shigetoshi Jogan, Osaka (JP); Masatoshi Enomoto, Osaka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/344,697

(22) PCT Filed: Aug. 21, 2001
(86) PCT No.: PCT/JP01/07162

(30) Foreign Application Priority Data
Aug. 22, 2000 (JP) 2000-250941

(51) Int. Cl. B05D 1/40

(52) U.S. Cl. 427/331; 427/256

(57) ABSTRACT

The present invention relates to a method of processing an article to be processed so as to cause the article to create rainbow color and a method of manufacturing an article made of aluminum or its alloy which presents rainbow-colored reflective luster. An aluminum plate is prepared as a substrate (2) of an article (1) to be processed. A nickel-phosphorus alloy deposit (3) is formed on the surface of this aluminum substrate (2) by an electroless plating method. Subsequently, this article is heat-treated at the temperature of 150 to 600° C. for 5 seconds to 1 hour in an air atmosphere. Subsequently, pulsed laser light (10) is irradiated onto the surface of the deposit (3). Be performing the aforementioned steps, diffraction gratings (5) which present beautiful rainbow-colored reflective luster can be assuredly formed in the surface of article (1). Furthermore, the processing speed can be further increased.

### TECHNICAL FIELD

The present invention relates to a method of processing an article to be processed so as to cause the article to create rainbow color, which is preferably applied to a surface of, for example, accessories, cosmetics containers, medical-supplies containers, transportation device components, interior/exterior walls of construction structures and/or a die for manufacturing these articles. It also relates to a method of manufacturing an article which presents rainbow-colored reflective luster, and further relates to an article which presents rainbow-colored reflective luster.

### BACKGROUND ART

As shown in Japanese Laid-open Patent Publications, for example, H6-198465 and H6-198466, a method of processing an article to be processed so as to cause the article to create rainbow color is publicly known. According to the method, a coat made of Cr₂O₃ or TiN as a laser optical waveguide is formed on a surface of an article to be processed made of stainless steel or titanium, and then pulsed laser light is irradiated onto the surface of the coat to thereby create diffraction gratings of minute unevenness which present rainbow-colored reflective luster on the surface of the article.

In detail, Japanese Laid-open Patent Publication H6-198465 discloses the following processing method of creating rainbow color. In this method, an article to be processed made of stainless steel or titanium is subjected to heat-treatment in a reactive gas atmosphere to create a coat of Cr₂O₃ or TiN as a laser optical waveguide on the surface of the article. Thereafter, laser light is irradiated onto the surface of the coat to create diffraction gratings. With this processing method, the processing operation efficiency can be improved by creating the coat by the heat-treatment.

This processing method of creating rainbow color utilizes the following phenomena. When pulsed laser light is irradiated onto the same position of the surface of the coat, the irradiated laser light is introduced into the coat via a minute blemish, a crystal grain boundary or the like existing on the surface of the coat, and advances within the coat in the direction of the field as a waveguide. Thus, this introduced laser light and the irradiated laser light interfere with each other to cause fusion and evaporation of the surface of the article to be processed corresponding to the interfered pattern. As a result, a minute unevenness is formed on the surface of the article to be processed. The minute unevenness constitutes diffraction gratings which cause spectrum reflection of light. As a result, when the minute unevenness is irradiated by light, such as sunlight or fluorescent lamp light, the tone of the reflected light looks different depending on the angle to be seen, creating a rainbow pattern.

The aforementioned diffraction gratings of minute unevenness can be formed by irradiating laser light while continuously moving the laser light or by irradiating spot-like laser light onto a predetermined position. According to this method, there is an advantage that a region which presents rainbow-colored reflective luster can be formed in any position of the surface of the article to be processed.

Accordingly, it is considered that this processing method of creating rainbow color can be preferably applied to a surface-decoration processing of accessories, industrial products, etc. Furthermore, it is expected that the processing method can also be applied to visual forge-prevention processing of prepaid cards such as telephone cards and pachinko cards.

By the way, such processing of creating rainbow color has an outstanding advantage of making colorful color which charms those who see the processed article. On the other hand, the processed article presents metallic luster since the natural complexion of the ground metal is exposed on the surface other than the portion where diffraction gratings are formed. As a result, there is a fault that a cold sensibility is given to those who see the processed article.

Furthermore, since the depth of the minute unevenness constituting the diffraction gratings which create rainbow color is several nm, there is a fault that the diffraction gratings are easily abraded.

Furthermore, some kinds of metallic material constituting the article to be processed are inappropriate for performing the processing method. For example, in cases where an article to be processed is made of aluminum or its alloy (hereinafter referred to simply as “aluminum”), even if laser light is irradiated onto the surface of the article, diffraction gratings will not be formed.

The present invention was made in view of the aforementioned technical backgrounds. It is an object of the present invention to provide a method of processing an article to be processed so as to cause the article to create rainbow color, wherein the method can be applied to any article regardless of the kind of materials, can create beautiful rainbow-colored reflective luster, can form abrasion-durable diffraction gratings, can create beautiful reflective luster to a surface other than the portion where diffraction gratings are formed, and can perform as quick as possible. It is another object of the present invention to provide a method of manufacturing an article which presents rainbow-colored reflective luster and such an article which presents rainbow-colored reflective luster.

Another objects of the present invention will be apparent from the following embodiments.

### DISCLOSURE OF INVENTION

According to the present invention, a method of processing an article to be processed so as to cause the article to create rainbow color, comprises the steps of: forming a nickel-phosphorus alloy deposit on a surface of an article to be processed; heat-treating the article to oxidize at least a surface portion of the deposit; and thereafter irradiating laser light on the surface of the deposit.

In accordance with this method, by forming the nickel-phosphorus alloy deposit on the surface of the article to be processed and then heat-treating the article in an oxygen atmosphere (for example, an atmospheric air), the nickel-phosphorus alloy deposit may be oxidized in the depth direction from the surface thereof, whereby at least the surface layer portion of the deposit is oxidized. That is, due to the aforementioned heat-treatment, an oxide film is formed at least in the surface layer portion of the deposit. Although it is surmised that the oxide film is 6 to 10 nm in thickness, the thickness is not limited to the above.

The laser light for forming diffraction gratings is irradiated onto the surface of the heat-treated deposit. Then, the laser light is introduced from the surface of the oxide film, and this introduced laser light and the irradiated laser light interfere with each other. As a result, diffraction gratings consisting of minute unevenness are formed on the surface of the article to be processed corresponding to the interference pattern.

Since a nickel-phosphorus alloy deposit can be formed on a surface of an article to be processed made of various kinds of metallic materials, when this nickel-phosphorus alloy deposit is formed on a surface of an article to be processed, the processing for creating rainbow color can be performed regardless of the kind of materials. Furthermore, this nickel-phosphorus alloy deposit has a high surface hardness of, for example, 1.5 times or more the surface hardness of a nickel deposit. Therefore, when diffraction gratings are formed on the surface of the nickel-phosphorus alloy deposit, it becomes possible to obtain diffraction gratings excellent in abrasion resistance.

Furthermore, the thickness of the oxide film increases with the heating time and the refractive index of this oxide film differs from that of the ground metal. Accordingly, when the oxide film is formed in the surface portion of the nickel-phosphorus alloy deposit, interference color caused by the difference between the refractive index of the oxide film and that of the ground metal will be created. On the other hand, since the surface other than the diffraction grating formed portion is covered by the oxide film, beautiful reflective luster caused by the interference color also comes to present on the surface other than the portion where diffraction gratings are formed. This interference color presents gold to purple. When the thickness of the oxide film is thick, it presents purple.

Therefore, when laser light is irradiated onto the surface of the oxide film to form diffraction gratings, rainbow color caused by the diffraction gratings will be added to the interference color due to the difference between the refraction index of the oxide film and that of the ground metal. Accordingly, it comes to present very beautiful rainbow color. On the other hand, since the oxide film covers the surface other than the diffraction grating formed portion, beautiful reflective luster by the interference color comes to arise also on the surface other than the diffraction grating formed portion.

It is desirable that the thickness of this nickel-phosphorus alloy deposit falls within the range of from 3 to 20 μm because of the following reasons. If the thickness is less than 3 μm, there is a possibility that it becomes impossible to form good diffraction grating due to the influence of the substrate of the article to be processed. On the other hand, if the thickness exceeds 20μm, there is a possibility that cracks may be generated in the oxide film. The most preferable thickness is from 10 to 15 μm.

As for the article to be processed, metal things, such as a product made of stainless steel or the like, can be used. Especially, it is preferable that the article to be processed is made of aluminum. Although it was, conventionally, impossible to directly form diffraction gratings in the surface of the article to be processed made of aluminum, the processing method of the present invention enables to form diffraction gratings in the surface of the article to be processed made of aluminum.

In the method of processing an article to be processed so as to cause the article to create rainbow color according to the present invention, it is preferable that the step of heat-treating the article is performed in an atmospheric air at the temperature of 150 to 600° C. for 5 seconds to 1 hour.

In this case, cracks which grow from intergranular corrosion or the like which may generate in an oxide film are prevented from generating, which enables to form an oxide film having a good surface condition and to produce interference color due to the difference of the refractive index assuredly. Accordingly, it becomes possible to assuredly form diffraction gratings which produce beautiful rainbow-colored reflective luster. Furthermore, it is especially preferable that the step of heat-treating the article is performed at the temperature of 300 to 400° C. Furthermore, it is especially preferable that the step of heat-treating the article is performed for 5 to 10 minutes.

Furthermore, it is preferable that the step of heat-treating the article is performed while covering a part of a surface of a deposit by an oxygen-interception mask.

In this case, the portion of the surface of the deposit covered by the mask is prevented from being oxidized. This causes generation of the aforementioned interference color at a predetermined portion, resulting in improved decoration effects.

In cases where diffraction gratings are formed by the scanning method in which laser light or an article to be processed is moved while irradiating laser light, it is possible to form diffraction gratings which produce beautiful rainbow-colored reflective luster even if the moving speed of the irradiation laser light or the article to be processed is increased, resulting in improved processing operation efficiency. Although the moving speed of the laser light to the article to be processed can be set arbitrarily, the desirable speed is from 500 to 1,000 mm/min.

The method of processing an article to be processed so as to cause the article to create rainbow color according to the present invention can be applied to a manufacturing method of an article which presents rainbow-colored reflective luster, and preferably to, a manufacturing method of an article made of aluminum or its alloy which presents especially rainbow-colored reflective luster.

An article which presents rainbow-colored reflective luster according to the present invention includes a nickel-phosphorus alloy deposit formed on a surface of the article, an oxide film of an oxide layer of the deposit formed on at least a surface portion of the deposit, and diffraction gratings which produce rainbow-colored reflective luster formed on the surface of the oxide film.

It is preferable that the deposit is 3 to 20 μm in thickness.

An article made of aluminum or its alloy which presents rainbow-colored reflective luster according to the present invention includes a nickel-phosphorus alloy deposit formed on a surface of the article made of aluminum or its alloy, an oxide film of an oxide layer of the deposit formed in at least a surface portion of the deposit, and diffraction gratings which produce rainbow-colored reflective luster formed on the surface of the oxide film.

It is preferable that the deposit is 3 to 20 μm in thickness.

### BRIEF DESCRIPTION OF DRAWINGS

FIG. 1 is a cross-sectional view of an article to be processed for explaining the procedures of the method of processing an article to be processed so as to cause the article to create rainbow color according to the present invention; and

FIG. 2 is a perspective view of the article to be processed for explaining another preferable method of processing an article to be processed so as to cause the article to create rainbow color according to the present invention.

### BEST MODE FOR CARRYING OUT THE INVENTION

The present invention will be fully explained with reference to the attached drawings.

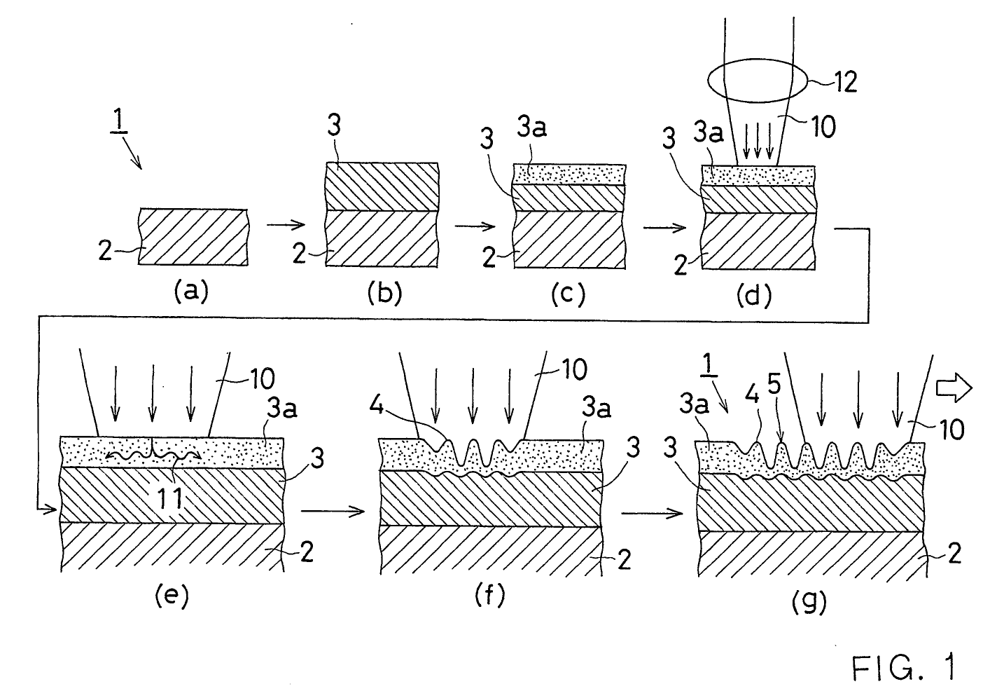

FIG. 1 (a)-(g) show the cross-sectional views of the article to be processed for explaining the procedures of the preferable method of processing an article to be processed so as to cause the article to create rainbow color according to the present invention.

In FIG. 1(a), the reference numeral 1 denotes a metal article to be processed. In this embodiment, the article to be processed 1 is an aluminum plate 2. Even if laser light is irradiated directly onto the surface of such an aluminum plate 2, expected diffraction gratings cannot be formed.

Therefore, in the present invention, as shown in FIG. 1(b), nickel-phosphorus alloy is deposited on the surface of the aluminum plate 2 as a substrate by electroless plating. Thus, the nickel-phosphorus alloy deposit 3 is formed on the surface of the aluminum substrate 2. As for the thickness of this deposit 3, it is desirable that the thickness falls within the range of from 3 to 20 μm because of the following reasons. If the thickness is less than 3 μm, there is a possibility that it becomes impossible to form good diffraction gratings (see reference numeral 5 in FIG. 1(g)) due to the influence of the aluminum substrate 2. On the other hand, if the thickness exceeds 20 μm , there is a possibility that cracks may be generated in the oxide film (see reference numeral 3a in FIG. 1(c)). The preferable thickness is from 10 to 15 μm.

The formation of the nickel-phosphorus alloy deposit 3 by the aforementioned electroless plating may be performed by a conventional method. One example thereof will be explained briefly. As a pretreatment of the surface of the aluminum substrate 2, degreasing processing of the surface of the substrate is performed. Subsequently, after etching (caustic wash) the substrate, the etched substrate is subjected to zincate processing. Thereafter the substrate is washed by nitric acid. Then, this aluminum substrate 2 is immersed in ammonia solution of nickel salts, such as nickel chloride, to deposit nickel-phosphorus alloy on the surface of the aluminum substrate 2. The aforementioned ammonia solution includes sodium hypophoshite.

In this way, after forming the nickel-phosphorus alloy deposit 3 on the surface of the aluminum substrate 2, this article 1 to be processed is subjected to heat-treating by a known heating means in an atmospheric air at the temperature of 150 to 600° C. for 5 seconds to 1 hour. If the temperature is lower than 150° C. or the heating time is less than 5 seconds, there is a possibility that good diffraction gratings cannot be formed because of insufficient heating. On the other hand, if the temperature exceeds 600° C. or the heating time exceeds 1 hour, there is a possibility that good diffraction gratings cannot be formed because of excessive oxidization. Accordingly, it is desirable to perform the heat-treatment at the temperature of 150 to 600° C. for 5 seconds to 1 hour.

By this heat-treatment, the deposit 3 is oxidized toward the depth direction from the surface. As a result, as shown in this FIG. 1(c), the oxide film 3a of the oxidized layer of the deposit 3 is formed in the surface portion of this deposit 3. The surface of this oxide film 3a creates interference color due to the difference between the refractive index of the oxide film 3a and that of the ground metal. This interference color presents gold to purple.

It is desirable that the heating temperature in this heat-treatment is from 300 to 400° C. The nickel-phosphorus alloy deposit 3 before heat-treatment is usually in an amorphous state and this deposit 3 is crystallized probably at the heating temperature of 250 to 300° C. It is surmised that the whole deposit 3 will be crystallized and the surface portion of this deposit 3 will be oxidized when the article is heat-treated at the temperature of 300 to 400° C. We found that diffraction gratings that present very beautiful reflective luster can be formed by irradiating laser light on the surface of the crystallized and oxidized deposit 3. More preferably, the heating time is from 5 to 10 minutes.

Subsequently, as shown in this FIG. 1(d), in the same manner as in the conventional method of processing an article to be processed so as to cause the article to create rainbow color, using Q switch Nd:YAG laser light of a linearly polarized light as a pulsed laser light 10 in a single mode, this laser light 10 is irradiated so that many pulses are irradiated on the same position on the surface of the oxide film 3a. Usually, the laser light 10 is irradiated in the out-of-focus state. Furthermore, as the irradiation laser light, although slag, excimer laser, etc. may be used, it is desirable to use YAG laser light as in this embodiment. The reference numeral 12 denotes a convex lens converging the laser light 10.

Thus, as shown in this FIG. 1(e), the irradiated laser light is introduced into the oxide film 3 through a minute blemish, a minute crystal grain boundary or the like which exists on the surface of the oxide film 3a, and advances in the direction of the field through the oxide film 3a as a waveguide. Then, this introduced laser light 11 and the irradiation laser light 10 interfere with each other, and the surface of the oxide film 3a is fused and evaporated corresponding to the interference pattern. As a result, as shown in FIG. 1(f), minute unevenness 4 is formed. This minute unevenness 4 constitutes diffraction gratings which disperse and reflect light, and function as a diffraction grating coupler. As shown in FIG. 1(g), by moving the laser light 10 or moving the article 1 to be processed while irradiating the laser light 10, predetermined diffraction gratings 5 are formed along the irradiation locus line of the laser light 10 on the surface of the article 1 to be processed.

The obtained article 1 to which the aforementioned processing is performed has the region which presents beautiful rainbow-colored reflective luster on the surface. Thus, the article 1 can be used as accessories. Furthermore, since the substrate 2 is made of aluminum, very lightweight accessories can be obtained.

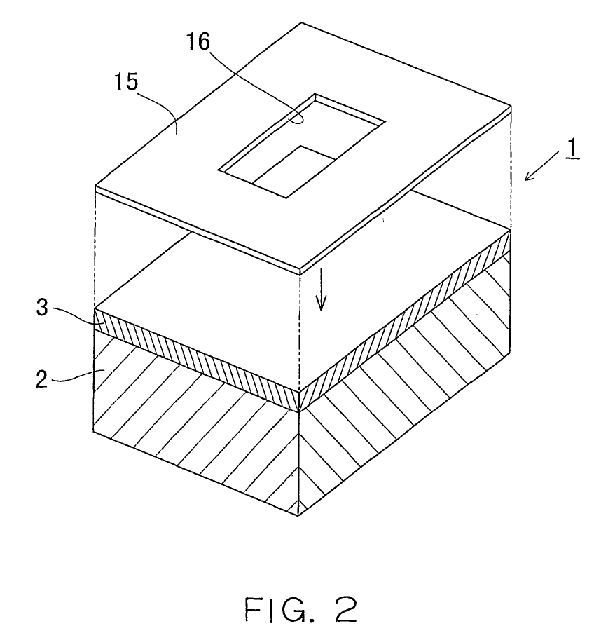

FIG. 2 is a perspective view of an article to be processed for explaining another preferable method of processing an article to be processed so as to cause the article to create rainbow according to the present invention.

According to this method, an oxygen-interception plate 15 having a rectangular aperture 16 is used. At the time of the heat-treatment, the mask plate 15 is disposed on the surface of the nickel-phosphorus alloy deposit 3 to cover a part of the surface of the deposit 3. Then, in this covered state, the article 1 is heat-treated. After heat-treatment performed in this way, the mask plate 15 is removed from the surface of the deposit 3. The other processing conditions are the same as the aforementioned processing conditions.

According to this method, only the surface portion of the deposit 3 exposed through the aperture 16 is oxidized, and only this exposed surface portion comes to present interference color.

Next, concrete examples of the present invention will be explained.

As a substrate of an article to be processed, aluminum plates (material: Japanese Industrial Standards A1100, dimension: 50 mm×50 mm×0.1 mm thickness) were prepared, and a layer was formed on the surface of each aluminum substrate as follows.

### EXAMPLES 1-9

The aluminum substrates were pretreated (degreasing processing→Fetching by the caustic wash→zincate processing→nitric acid washing). Then, according to the conventional method, nickel—phosphorus (Ni—P) alloy deposit (thickness: see Table 1) was formed on the surface of each aluminum substrate by electroless plating. Subsequently, these substrates were heat-treated in an air atmosphere at different heating temperature falling within the range of from 150 to 600° C. for different heating time falling within the range of from 5 seconds to 1 hour. These heat-treatments were performed in a heating furnace. The conditions of the heat-treatment are also shown in Table 1. These samples are designated as examples 1 to 9.

TABLE 1

| | | | Heating time | | | Evalu- |
|---|---|---|---|---|---|---|
| | Layer | | Heating | | | ation |
| | | Thickness | temperature | Heating | | (see |
| Sample | Type | (μm) | (° C.) | time | | Notes) |
| Example 1 | Ni-P alloy | 10 | 150 | 5 | sec. | ◯ |
| | deposit | | | | | |
| Example 2 | Ni-P alloy | 10 | 150 | 1 | hour | ◯ |
| | deposit | | | | | |
| Example 3 | Ni-P alloy | 10 | 350 | 5 | min. | ⊚ |
| | deposit | | | | | |
| Example 4 | Ni-P alloy | 10 | 600 | 5 | sec. | ◯ |
| | deposit | | | | | |
| Example 5 | Ni-P alloy | 10 | 600 | 1 | hour | ◯ |
| | deposit | | | | | |
| Example 6 | Ni-P alloy | 3 | 400 | 10 | min. | ◯ |
| | deposit | | | | | |
| Example 7 | Ni-P alloy | 5 | 400 | 10 | min. | ◯ |
| | deposit | | | | | |
| Example 8 | Ni-P alloy | 15 | 400 | 10 | min. | ⊚ |
| | deposit | | | | | |
| Example 9 | Ni-P alloy | 20 | 400 | 10 | min. | ◯ |
| | deposit | | | | | |
| Comparative | Ni-P alloy | 10 | — | — | | X |
| Example 1 | deposit | | | | | |
| Comparative | Ni deposit | 10 | 400 | 10 | min. | X |
| Example 2 | | | | | | |

| | | | | | |
|---|---|---|---|---|---|
| Comparative | Alumite | 7 | — | — | X |
| Example 3 | | | | | |
| Comparative | None | — | — | — | X |
| Example 4 | | | | | |

Notes ⊚ Very good diffraction gratings were formed
◯ Good diffraction gratings were formed
X No diffraction grating was formed

### Comparative Example 1

A nickel-phosphorus alloy deposit (10 μm thickness) was formed on the surface of the aluminum substrate in the same manner as in the aforementioned examples. This sample is designated as comparative example 1.

### Comparative Example 2

According to a conventional method, a nickel-plating layer (10 μm thickness) was formed on the surface of the aluminum substrate. Subsequently, the substrate was heat-treated in a heating furnace in an air atmosphere at the heating temperature of 400° C. for 10 minutes. This sample is designated as comparative example 2.

### Comparative Example 3

According to a conventional method, an alumite layer (7 μm thickness) of oxalic acid was formed on the surface of the aluminum substrate. This sample is designated as comparative example 3.

### Comparative Example 4

No layer was formed on the surface of the aluminum substrate. This sample is designated as comparative example 4.

To the aforementioned examples 1 to 9 and the aforementioned comparative examples 1 to 4, Q switch Nd:YAG laser light of a linearly polarized light was irradiated on the surface of each example in order to form diffraction gratings under the conditions of the oscillation wavelength of 1.06 μm, the pulse widths of 100 ns, the laser light repeats of 1 kHz and the laser light output of 2W.

The results are shown in Table 1.

As shown in Table 1, the samples of examples 1-9 reveal that no crack is generated in the surface thereof and diffraction gratings which produce beautiful rainbow-colored reflective luster can be obtained.

Furthermore, the samples of the examples 1-9 reveal that diffraction gratings can be formed at the very fast moving speed of irradiation laser light, such as 500 to 1000 mm/min, and the processing operation efficiency is excellent.

On the other hand, the samples of comparative examples 1-4 reveal that diffraction gratings which present beautiful reflective luster cannot be obtained because cracks generated in the surface deteriorates the surface status when the moving speed of the irradiation laser light is 500- 1000 mm/min, or even the speed is decreased to 1 mm/min.

Furthermore, as a substrate of an article to be processed, a stainless steel plate (material: SUS304, dimension: 50 mm×50 mm×0.1 mm thickness) was prepared, and the nickel-phosphorus alloy deposit (10 μm thickness) was formed on the surface of the stainless steel plate in the same manner as in the aforementioned aluminum substrate.

In this case too, the samples to which heat treating were performed at the temperature of 150 to 600° C. for 5 seconds to 1 hour reveal that diffraction gratings which produce beautiful rainbow-colored reflective luster can be obtained under the aforementioned conditions. Furthermore, it reveals that diffraction gratings can be formed at the very high working speed, such as the working speed of 500 to 1,000 mm/min, and the processing operation efficiency is excellent.

As will be understood from the above, according to the method of processing an article to be processed so as to cause the article to create rainbow color according to the present invention, it is possible to make the article to present very beautiful rainbow color that the interference color due to the difference between the refractive index of the oxide film of the nickel-phosphorus alloy deposit and that of the ground metal is added to rainbow color due to the diffraction gratings. Furthermore, the surface other than the diffraction grating formed portion can also present beautiful reflective luster due to the interference color.

Furthermore, according to the method of processing an article to be processed so as to cause the article to create rainbow color according to the present invention, diffraction gratings can be formed even if the construction material of the article to be processed consists of an aluminum which was not able to form diffraction gratings on the surface conventionally. Accordingly, an article to be processed is not restricted by the kind of construction material, which contributes to expand the application.

Furthermore, since the surface hardness of nickel-phosphorus alloy deposit is high, it becomes possible to form high-abrasion diffraction gratings, or high-durability diffraction gratings.

Furthermore, in cases where the thickness of the nickel-phosphorus alloy deposit falls within the range of from 3 to 20 μm, good diffraction gratings can be formed assuredly.

Furthermore, in cases where the article to be processed is heat-treated at the temperature of 150 to 600° C. for 5 seconds to 1 hour in an air atmosphere, diffraction gratings which produce beautiful rainbow-colored reflective luster can be formed assuredly.

Furthermore, in cases where the step of heat-treating the article is performed while covering a part of a surface of the deposit by an oxygen-interception mask, it becomes possible to make only a desired portion to present interference color.

In cases where the step of irradiating laser light is performed by moving the laser light relative to the article to be processed at a speed of 500 to 1,000 mm/min, the processing operation efficiency can be improved.

According to a method of manufacturing an article which presents rainbow-colored reflective luster, the same effects as mentioned above can be obtained.

Furthermore, according to a method of manufacturing an article made of aluminum or its alloy which presents rainbow-colored reflective luster, the same effects as mentioned above can be obtained.

Furthermore, according to an article which presents rainbow-colored reflective luster, an article equipped with diffraction gratings with outstanding durability can be obtained. In cases where the article is made of aluminum or its alloy, a lightweight article can be obtained.

This application claims priority to Japanese Patent Application No. 2000-250941 filed on Aug. 22, 2000, the disclosure of which is incorporated by reference in its entirety.

The terms and descriptions in this specification are used only for explanatory purposes and the present invention is not limited to these terms and descriptions. It should be appreciated that there are many modifications and substitutions without departing from the spirit and the scope of the present invention which is defined by the appended claims.

### INDUSTRIAL APPLICABILITY

A method of processing an article to be processed so as to cause the article to create rainbow color according to the present invention can be applied to processing for decorating, for example, accessories, cosmetics containers, medical-supplies containers, transportation device components, interior/exterior walls of construction structures. It can also be applied to visual forge-prevention processing of prepaid cards.

A method of manufacturing an article which presents rainbow-colored reflective luster can be applied to a manufacturing method for manufacturing, for example, accessories, cosmetics containers, medical-supplies containers, transportation device components, interior/exterior walls of construction structures. It can also be applied to a method of manufacturing prepaid cards.

An article which presents rainbow-colored reflective luster can be applied to, for example, accessories, cosmetics containers, medical-supplies containers, transportation device components, interior/exterior walls of construction structures.

1. A method of processing an article to be processed so as to cause the article to create rainbow color, the method comprising the steps of:
forming a nickel-phosphorus alloy deposit on a surface of an article to be processed;
heat-treating said article to oxidize at least a surface portion of said deposit; and thereafter
irradiating laser light on said surface of said deposit.

2. The method as recited in claim 1, wherein the step of forming said nickel-phosphorus alloy deposit is performed so as to have a thickness of from 3 to 20 μm.

3. The method as recited in claim 1, wherein the step of heat-treating said article is performed in an atmospheric air at the temperature of 150 to 600° C. for 5 seconds to 1 hour.

4. The method as recited in claim 3, wherein the step of heat-treating said article is performed at the temperature of 300 to 400° C.

5. The method as recited in claim 3, wherein the step of heat-treating said article is performed for 5 to 10 minutes.

6. The method as recited in claim 1, wherein the step of heat-treating said article is performed while covering a part of a surface of said deposit by an oxygen-interception mask.

7. The method as recited in claim 1, wherein the step of irradiating laser light is performed by moving said laser light relative to said article to be processed at a speed of 500 to 1000 mm/min.

8. A method of processing an article to be processed so as to cause the article to create rainbow color, the method comprising the steps of:
forming a nickel-phosphorus alloy deposit on a surface of an article to be processed made of aluminum or its alloy;
heat-treating said article to oxidize at least a surface portion of said deposit; and thereafter
irradiating laser light on said surface of said deposit.

9. The method as recited in claim 8, wherein the step of forming said nickel phosphorus alloy deposit is performed so as to have a thickness of from 3 to 20 μm.

10. The method as recited in claim 8, wherein the step of heat-treating said article is performed in an atmospheric air at the temperature of 150 to 600° C. for 5 seconds to 1 hour.

11. The method as recited in claim 10, wherein the step of heat-treating said article is performed at the temperature of 300 to 400° C.

12. The method as recited in claim 10, wherein the step of heat-treating said article is performed for 5 to 10 minutes.

13. The method as recited in claim 8, wherein the step of heat-treating said article is performed while covering a part of a surface of said deposit by an oxygen-interception mask.

14. The method as recited in claim 8, wherein the step of irradiating laser light is performed by moving said laser light relative to said article to be processed at a speed of 500 to 1000 mm/min.

15. A method of manufacturing an article which presents rainbow-colored reflective luster, the method comprising the steps of:
forming a nickel-phosphorus alloy deposit on a surface of an article to be processed;
heat-treating said article to oxidize at least a surface portion of said deposit; and thereafter
irradiating laser light on said surface of said deposit.

16. The method as recited in claim 15, wherein the step of forming said nickel phosphorus alloy deposit is performed so as to have a thickness of from 3 to 20 μm.

17. The method as recited in claim 15, wherein the step of heat-treating said article is performed in an atmospheric air at the temperature of 150 to 600° C. for 5 seconds to 1 hour.

18. The method as recited in claim 17, wherein the step of heat-treating said article is performed at the temperature of 300 to 400° C.

19. The method as recited in claim 17, wherein the step of heat-treating said article is performed for 5 to 10 minutes.

20. The method as recited in claim 15, wherein the step of heat-treating said article is performed while covering a part of a surface of said deposit by an oxygen-interception mask.

21. The method as recited in claim 15, wherein the step of irradiating laser light is performed by moving said laser light relative to said article to be processed at a speed of 500 to 1000 mm/min.

22. A method of manufacturing an article made of aluminum or its alloy which presents rainbow-colored reflective luster, the method comprising the steps of:
forming a nickel-phosphorus alloy deposit on a surface of an article to be processed made of aluminum or its alloy;
heat-treating said article to oxidize at least a surface portion of said deposit; and thereafter
irradiating laser light on said surface of said deposit.

23. The method as recited in claim 22, wherein the step of forming said nickel phosphorus alloy deposit is performed so as to have a thickness of from 3 to 20 μm.

24. The method as recited in claim 22, wherein the step of heat-treating said article is performed in an atmospheric air at the temperature of 150 to 600° C. for 5 seconds to 1 hour.

25. The method as recited in claim 24, wherein the step of heat-treating said article is performed at the temperature of 300 to 400° C.

26. The method as recited in claim 24, wherein the step of heat-treating said article is performed for 5 to 10 minutes.

27. The method as recited in claim 22, wherein the step of heat-treating said article is performed while covering a part of a surface of said deposit by an oxygen-interception mask.

28. The method as recited in claim 22, wherein the step of irradiating laser light is performed by moving said laser light relative to said article to be processed at a speed of 500 to 1000 mm/min.

29. An article which presents rainbow-colored reflective luster manufactured by the method defined by claim 15 or 22.

30. An article which presents rainbow-colored reflective luster, said article comprising:
a nickel-phosphorus alloy deposit formed on a surface of said article;
an oxide film of an oxide layer of said deposit formed in at least a surface portion of said deposit; and
diffraction gratings which produce rainbow-colored reflective luster formed in said surface of said oxide film.

31. The article as recited in claim 30, wherein said deposit is 3 to 20 μm in thickness.

32. An article made of aluminum or its alloy which presents rainbow-colored reflective luster, said article comprising:
a nickel-phosphorus alloy deposit formed on a surface of said article made of aluminum or its alloy;
an oxide film of an oxide layer of said deposit formed in at least a surface portion of said deposit; and
diffraction gratings which produce rainbow-colored reflective luster formed in said surface of said oxide film.

33. The article as recited in claim 32, wherein said deposit is 3 to 20 μm in thickness.
